(19) United States
(12) Patent Application Publication
(10) Pub. No.: US 2006/0292400 A1
(43) Pub. Date: Dec. 28, 2006

(54) Magnetic recording medium, magnetic recording and reproducing apparatus, and method for manufacturing magnetic recording medium

(75) Inventors: Takahiro Suwa, Tokyo (JP); Kazuhiro Hattori, Tokyo (JP); Shuichi Okawa, Tokyo (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 11/472,419

(22) Filed: Jun. 22, 2006

(30) Foreign Application Priority Data
Jun. 24, 2005 (JP) 2005-185449

(51) Int. Cl. G11B 5/64; G11B 5/65

(52) U.S. Cl. 428/826; 428/833.1; 427/127

(57) ABSTRACT

A magnetic recording medium that includes a recording layer formed in a predetermined concavo-convex pattern in which recording elements are formed as convex portions, has high areal density, cannot cause crash of a magnetic head easily, and has high reliability, and a magnetic recording and reproducing apparatus including that magnetic recording medium are provided. The magnetic recording medium includes: the recording elements formed as the convex portions of the recording layer formed in a predetermined concavo-convex pattern over a substrate; and a filling material with which a concave portion between the recording elements is filled. The surface roughness of a portion of a surface of the medium above the filling material is larger than that of portions of the surface above the recording elements.

### BACKGROUND OF THE INVENTION

1. Field of the Invention

The present invention relates to a magnetic recording medium including a recording layer formed in a predetermined concavo-convex pattern in which recording elements are formed as convex portions, a magnetic recording and reproducing apparatus including that magnetic recording medium, and a method for manufacturing the magnetic recording medium.

2. Description of the Related Art

Conventionally, for a magnetic recording medium such as a hard disk, various types of development such as miniaturization of magnetic particles forming a recording layer, a change in a material for the magnetic particles, and miniaturization of heading have been made to largely improve areal density of the recording layer. The improvement of the areal density is expected to continue. However, many problems including limitation of the magnetic head processing, erroneous recording of information on a track adjacent to a target track caused by broadening of a recording magnetic field of the magnetic head, crosstalk during reproduction, and the like are made apparent. Thus, the improvement of the areal density by the conventional development approaches has reached the limit.

As candidates of a magnetic recording medium that can further improve the areal density, a discrete track medium and a patterned medium in each of which a recording layer is formed in a concavo-convex pattern and recording elements are formed as convex portions of the concavo-convex pattern have been proposed (see Japanese Patent Laid-Open Publication No. Hei 9-97419, for example). As the areal density is higher, a magnetic gap between a magnetic head and a magnetic recording medium is smaller. Therefore, for a magnetic recording medium that is expected to have an areal density of 200 Gbpsi or more, such as the discrete track medium and patterned medium, there is a guideline that the magnetic gap between the magnetic head and the magnetic recording medium should be 15 nm or less.

Moreover, for a magnetic recording medium such as a hard disk, flatness of a surface thereof is important in order to suppress crash of the magnetic recording medium with the magnetic head. The surface flatness is very important especially for the discrete track medium and patterned medium that have a high areal density and a small magnetic gap. Thus, it is preferable to deposit a nonmagnetic filling material over the recording layer having the concavo-convex pattern so as to fill concave portions between the recording elements with the filling material and then remove an excess part of the filling material so as to flatten a top surface of the recording elements and filling material. As a method for filling the concave portions with the filling material, sputtering, CVD (Chemical Vapor Deposition), IBD (Ion Beam Deposition), and the like can be used. As a flattening technique, CMP (Chemical Mechanical Polishing), dry etching, and the like can be used (see Japanese Patent Laid Open Publication No. Hei 12-195042 and Japanese Translation of PCT International Application No. Hei 14-515647, for example).

However, when the surface of the magnetic recording medium is excessively flat, stiction of the magnetic head to the surface of the magnetic recording medium can easily occur and therefore crash of the magnetic recording medium with the magnetic head can easily occur. In order to prevent this problem, according to a conventional technique, a texture process is performed for a surface of a substrate and a recording layer and other layers are sequentially deposited on that surface, thereby forming a fine concavo-convex pattern following the texture pattern on the substrate on the surface of the magnetic recording medium so as to prevent the crash with the magnetic head caused by stiction. For the discrete track medium and the patterned medium, another structure is also known in which a step is provided between a portion of the surface of the medium above the recording element and a portion above the filling material (See Japanese Patent Laid-Open Publication No. Hei 1-279421, for example). Therefore, a technique for providing a texture effect by using this step is conceivable.

When a concavo-convex pattern is formed on the surface of the magnetic recording medium by performing the texture process for the substrate, however, the surface is distorted with undulation having a period of approximately 100 nm to approximately 2 μm. It is difficult for the magnetic head to fly following the distortion with the undulation having the period of about 100 nm to about 2 μm. Thus, that distortion with the undulation leads to a variation in a magnetic gap. Such a variation in the magnetic gap gives no practical problem in a generation having a magnetic gap of 25 nm or more. However, when the magnetic gap is 15 nm or less, the above variation in the magnetic gap has an adverse effect that is not acceptable from a practical viewpoint.

Moreover, even if the texture process is performed for the surface of the substrate, when the filling material is deposited over the recording layer having a concavo-convex pattern to fill the concave portions between the recording elements with the filling material and then the excess part of the filling material is removed to flatten the top surface of the recording elements and the filling material, fine concavities and convexities that follow the texture pattern on the substrate are inevitably removed. Thus, in this case, it is difficult to form a desired fine concavo-convex pattern on the surface of the magnetic recording medium by using this technique.

In addition, in the technique to provide the step between the portion of the surface above the recording element and the portion above the filling material, rigidity of an air film between the magnetic head and the surface of the magnetic recording medium becomes so small that flight of the magnetic head becomes unstable. Due to this, a large variation in the flying height of the magnetic head can easily occur by some disturbance, and therefore sufficient reliability cannot be obtained.

### SUMMARY OF THE INVENTION

In view of the foregoing problems, various exemplary embodiments of this invention provide a magnetic recording medium which includes a recording layer formed in a predetermined concavo-convex pattern in which recording elements are formed as convex portions to achieve high areal density, cannot cause crash of a magnetic head easily, and has high reliability, and a magnetic recording and reproducing apparatus including that magnetic recording medium.

Various exemplary embodiments of the present invention provide a magnetic recording medium in which a surface roughness of a portion of its surface above a filling material is larger than that of portions of the surface above recording elements, thereby achieving the above object.

By making the surface roughness of the portion of the surface above the filling material larger, occurrence of crash of a magnetic head caused by stiction can be suppressed.

Moreover, a texture effect is given by making the surface roughness of the portion of the surface above the filling material larger. Thus, an air film between the magnetic recording medium and the magnetic head can have higher rigidity than that obtained in a structure in which the texture effect is given by a step between the portion above the recording element and the portion above the filling material. Therefore, a variation in a flying height of the magnetic head can be suppressed. In addition, the variation in the flying height of the magnetic head can also be suppressed by making the surface roughness of the portions of the surface above the recording elements smaller. Thus, good magnetic characteristics can be obtained.

Furthermore, a variation in a magnetic gap between the recording elements and the magnetic head can also be suppressed by making the surface roughness of the top surface of the recording elements smaller. With regard to this point, good magnetic characteristics can also be obtained.

Accordingly, various exemplary embodiments of the present invention provide a magnetic recording medium comprising: recording elements formed as convex portions of a recording layer formed in a predetermined concavo-convex pattern over a substrate; and a filling material with which a concave portion between the recording elements is filled, and wherein a surface roughness of a portion of a surface of the medium above the filling material is larger than a surface roughness of portions of the surface above the recording elements.

Moreover, various exemplary embodiments of the present invention provide a method for manufacturing a magnetic recording medium comprising: a filling material deposition step for depositing a filling material over a recording layer that is formed in a predetermined concavo-convex pattern over a substrate and includes recording elements formed as convex portions of the concavo-convex pattern, to fill a concave portion between the recording elements with the filling material; a coating member deposition step for depositing a coating member made of a different material from the filling material over the filling material; and a flattening step for removing an excess part of the filling material and coating member that is higher than a top surface of the recording elements by etching, and flattening a surface to make a surface roughness of a portion of the surface above the concave portion larger than a surface roughness of portions of the surface above the recording elements.

As employed herein, the expression “recording layer formed in a predetermined concavo-convex pattern over a substrate” shall be used to include a recording layer obtained by dividing a continuous recording layer into a number of recording elements in a predetermined pattern, a recording layer obtained by partially dividing a continuous recording layer in a predetermined pattern in such a manner that the recording layer is formed by recording elements continuing each other partially, a recording layer continuously formed over part of a substrate such as a spirally formed recording layer, a continuous recording layer including both convex portions and a concave portions, and a recording layer separately formed in upper parts of convex portions and bottom parts of concave portions.

As employed herein, the expression “a portion of surface of a medium above recording element” shall mean, when a top surface of recording element 102 that is opposite to a substrate 104 is completely coated with another layer, as shown in FIG. 22, a top surface of an outermost layer 106 above the recording element 102; when the top surface of the recording element is partially exposed and a remaining portion of that top surface is coated with another layer, the exposed top surface of the recording element and the top surface of the outermost layer; and when the top surface of the recording element is completely exposed, the top surface of the recording element. This is the same for “a portion of surface of a medium above a filling material.” Please note that the reference numeral 108 in FIG. 22 denotes a filling material. Moreover, when a stop film 110 is formed on the top surface of the recording element 102 and is also formed on side faces of the recording element 102, as shown in FIG. 22, a portion of the surface above the stop film 110 located between the side face of the recording element 102 and the side face of the filling material 108 is included in “the portion of the surface of the medium above the recording element” herein.

Moreover, as employed herein, the term “magnetic recording medium” is not limited to a hard disk, a floppy (TM) disk, a magnetic tape, and the like which use magnetism alone when recording and reading information. The term shall also refer to a magneto-optic recording medium which uses both magnetism and light, such as an MO (Magneto Optical), and a recording medium of thermal assisted type which uses both magnetism and heat.

The term “arithmetical mean deviation” employed herein shall mean arithmetical mean deviation defined in accordance with JIS-B0601-2001.

The term “etching rate” employed herein shall mean the processed amount in a thickness direction within unit time.

Various exemplary embodiments of the present invention can achieve a magnetic recording medium which includes a recording layer formed in a concavo-convex pattern in which recording elements are formed as convex portions to achieve high areal density, cannot cause crash of a magnetic head easily, and has high reliability, and a magnetic recording and reproducing apparatus including that magnetic recording medium.

### BRIEF DESCRIPTION OF THE DRAWINGS

FIG. 1 is a perspective view schematically showing a general structure of a main part of a magnetic recording and reproducing apparatus according to a first exemplary embodiment of the present invention;

FIG. 2 is a cross-sectional side view schematically showing a structure of a magnetic recording medium of the magnetic recording and reproducing apparatus;

FIG. 3 is an enlarged cross-sectional side view schematically showing a portion of the magnetic recording medium near a surface thereof;

FIG. 4 is a further enlarged cross-sectional side view schematically showing the portion near the surface of the magnetic recording medium;

FIG. 5 is a flowchart generally showing a manufacturing process of the magnetic recording medium;

FIG. 6 is a cross-sectional side view showing a workpiece in which a filling material is deposited over a recording layer having a concavo-convex pattern in the manufacturing process of the magnetic recording medium;

FIG. 7 is a cross-sectional side view showing the workpiece in which a coating member is deposited over the filling material;

FIG. 8 is a cross-sectional side view showing the workpiece in which portions of the coating member above recording elements are removed in a flattening process;

FIG. 9 is a cross-sectional side view showing the workpiece processed in which portions of the filling material above the recording elements are removed in the flattening step;

FIG. 10 is an enlarged cross-sectional side view schematically showing a structure of a magnetic recording medium near a surface thereof according to a second exemplary embodiment of the present invention;

FIG. 11 is an enlarged cross-sectional side view schematically showing a structure of a magnetic recording medium near a surface thereof according to a third exemplary embodiment of the present invention;

FIG. 12 is a cross-sectional side view schematically showing a structure of a magnetic recording medium near a surface thereof according to a fourth exemplary embodiment of the present invention;

FIG. 13 is an enlarged cross-sectional side view schematically showing a structure of a magnetic recording medium near a surface thereof according to a fifth exemplary embodiment of the present invention;

FIG. 14 is an enlarged cross-sectional side view schematically showing a structure of a magnetic recording medium near a surface thereof according to a sixth exemplary embodiment of the present invention;

FIG. 15 is an enlarged cross-sectional side view schematically showing a structure of a magnetic recording medium near a surface thereof according to a seventh exemplary embodiment of the present invention;

FIG. 16 is an enlarged cross-sectional side view schematically showing a structure of a magnetic recording medium near a surface thereof according to an eighth exemplary embodiment of the present invention;

FIG. 17 is an enlarged cross-sectional side view schematically showing a structure of a magnetic recording medium near a surface thereof according to a ninth exemplary embodiment of the present invention;

FIG. 18 is an AFM image showing concavities and convexities in a surface of a magnetic recording medium of Working Example 1 of the present invention;

FIG. 19 is a graph showing a variation in a flying height of a magnetic head for the magnetic recording medium of Working Example 1;

FIG. 20 is a graph showing a variation in a flying height of a magnetic head for a magnetic recording medium of Working Example 3 of the present invention;

FIG. 21 is a graph showing a variation in a flying height of a magnetic head for a magnetic recording medium of Comparative Example; and

FIG. 22 is a cross-sectional side view schematically showing a surface above recording elements and a surface above a filling material in the present application.

### DETAILED DESCRIPTION OF THE PREFERRED EMBODIMENTS

Preferred exemplary embodiments of the present invention will now be described in detail with reference to the drawings.

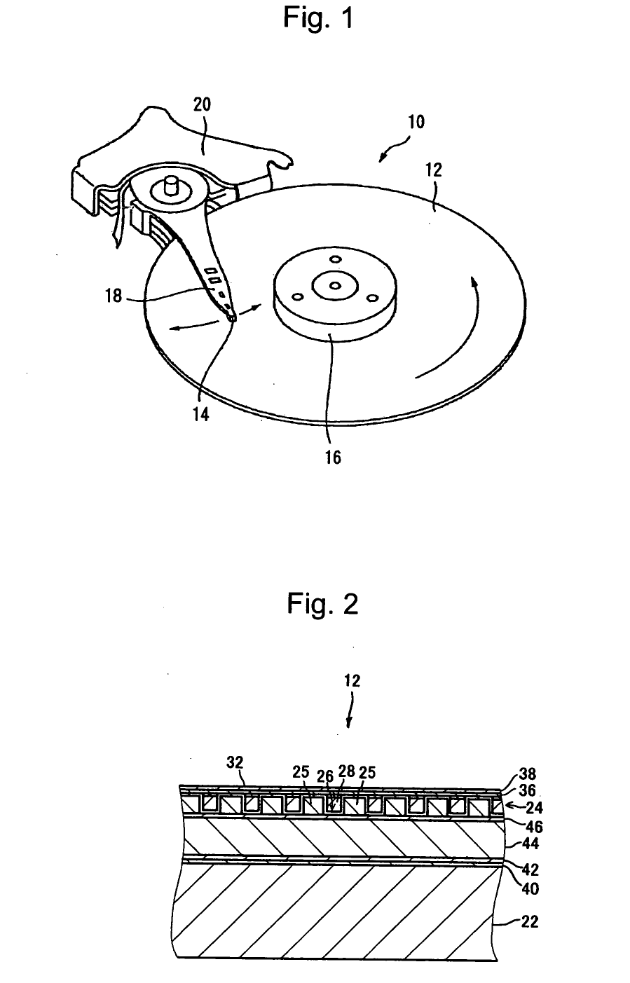

As shown in FIG. 1, a magnetic recording and reproducing apparatus 10 according to a first exemplary embodiment of the present invention includes a magnetic recording medium 12 and a magnetic head 14 arranged so that it can fly close to a surface of the magnetic recording medium 12 for recording and reproducing data for the magnetic recording medium 12. The magnetic recording and reproducing apparatus 10 has a feature in the configuration of the magnetic recording medium 12. Since the other configurations are not particularly indispensable to understanding the first exemplary embodiment of present invention, description thereof will be omitted when appropriate.

The magnetic recording medium 12 is fixed to a chuck 16 so that it can rotate with the chuck 16. The magnetic head 14 is mounted on near the top of an arm 18. The arm 18 is rotatably attached to a base 20. In consequence, the magnetic head 14 movably flies over the surface of the magnetic recording medium 12 so as to trace an arc along the radial direction Dr of the magnetic recording medium 12.

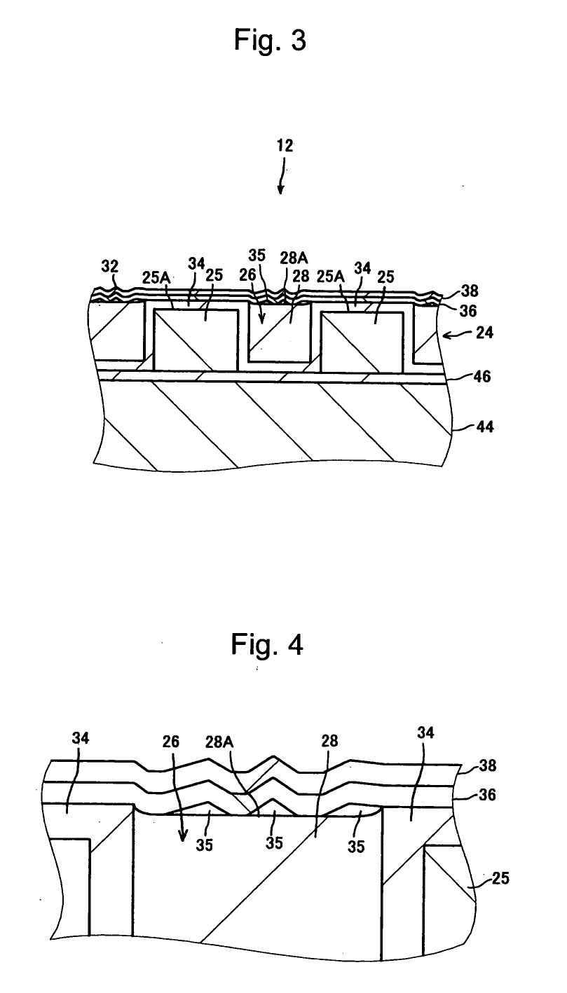

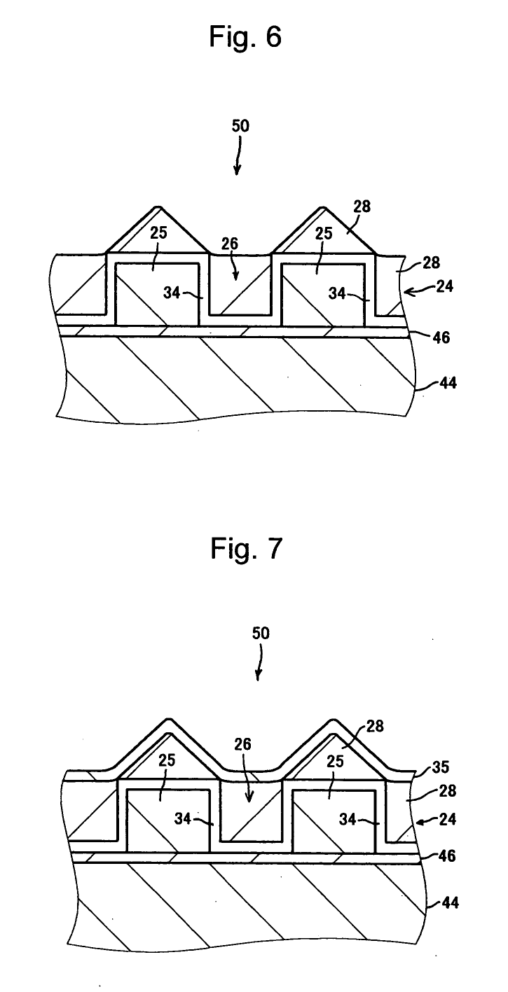

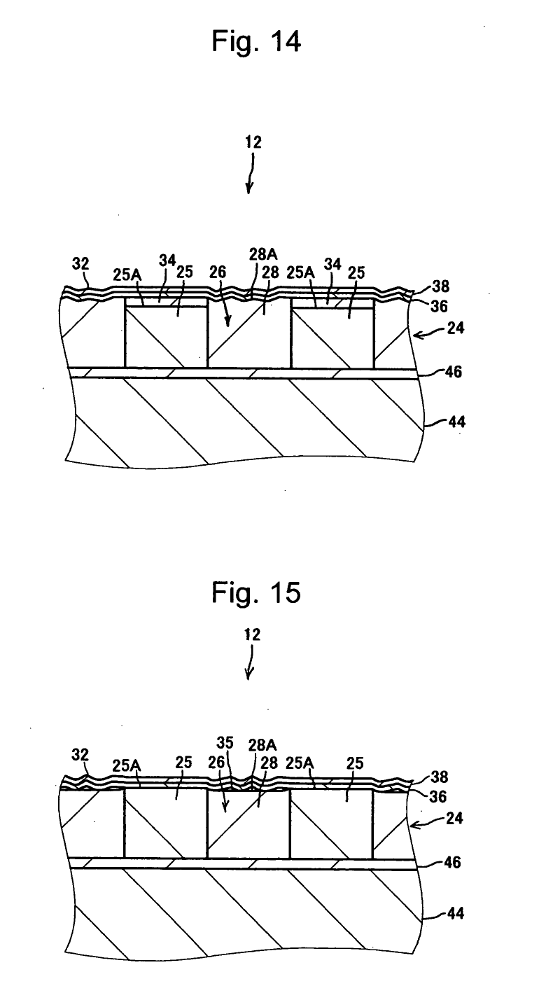

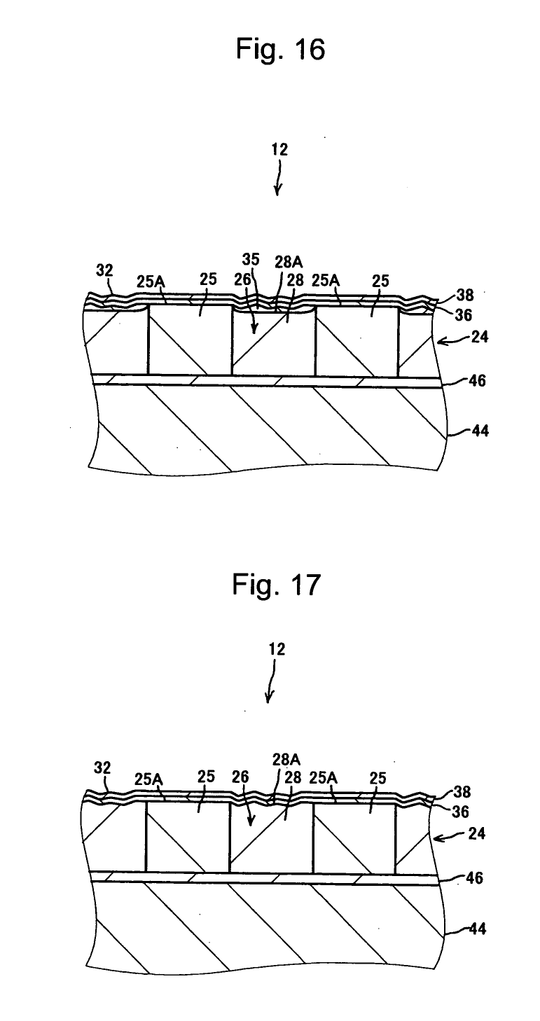

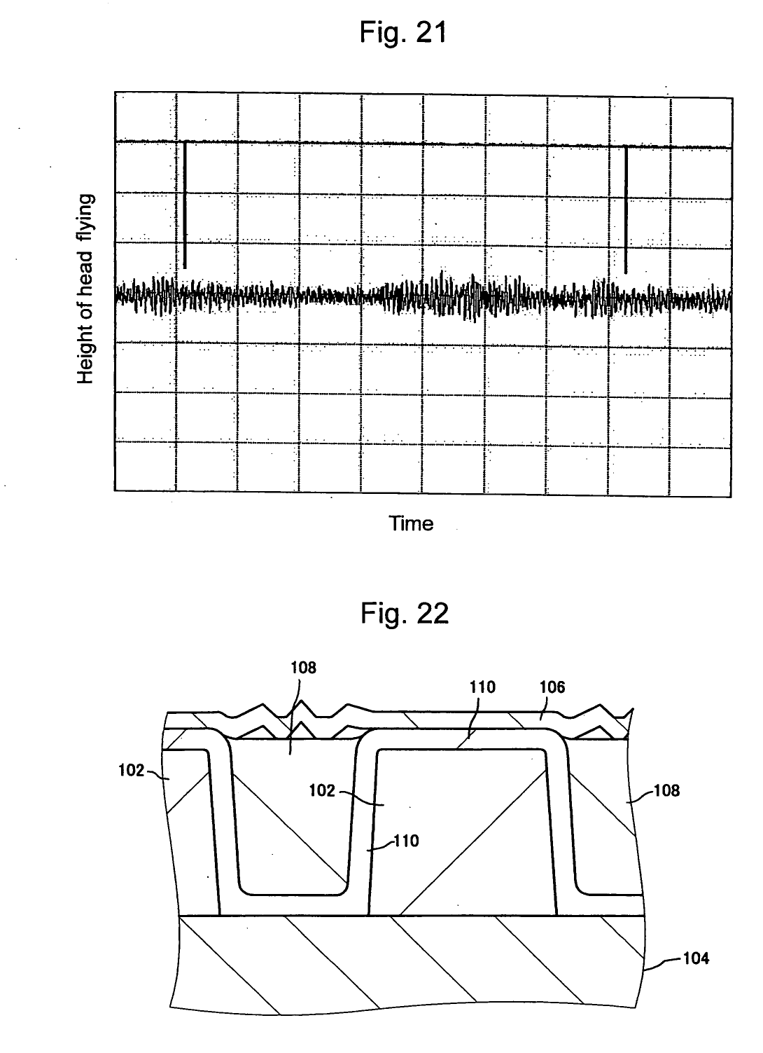

The magnetic recording medium 12 is a perpendicular recording type discrete track medium in the form of a circular plate. As shown in FIG. 2, the magnetic recording medium 12 includes recording elements 25 formed as convex portions of a recording layer 24 formed in a predetermined concavo-convex pattern over a substrate 22, and a nonmagnetic filling material 28 with which a concave portion 26 between the recording elements 25 is filled. The magnetic recording medium 12 is characterized in that the surface roughness of a portion of its surface 32 above the filling material 28 is larger than that of portions of the surface 32 above the recording elements 25, i.e., the surface 32 is rougher above the filling material 28 than above the recording elements 25, as shown in an enlarged manner in FIGS. 3 and 4. Please note that FIGS. 2 to 4 show the recording layer 24 as being thicker than actual thickness as compared with other layers in order to facilitate understanding of the first exemplary embodiment of present invention. This is the same for FIG. 22 described before and FIGS. 6 to 17 described later.

Here, the recording layer-side surface of the substrate 22 is mirror-polished. The substrate 22 may be made of nonmagnetic materials such as glass, Al alloys covered with NiP, Si, and Al₂O₃.

The recording layer 24 has a thickness of 5 to 30 nm. The recording layer 24 may be made of CoCr alloys such as a CoCrPt alloy, FePt alloys, laminates of those materials, a material in which ferromagnetic particles such as CoPt are contained in an oxide material such as SiO₂ in a matrix manner, for example.

The recording elements 25 are formed in the form of concentric tracks with a small radial interval in data areas. FIGS. 2 to 4 show those recording elements 25. In servo areas, the recording elements 25 are formed in a predetermined pattern representing servo information (not shown). The surface roughness of a top surface 25A of the recording elements 25 is smaller than that of the surface 32 above the filling material 28.

A stop film 34 is formed on the recording elements 25. The stop film 34 is also formed on side faces of the recording elements 25 and bottom faces of the concave portions 26. The stop film 34 may be made of Ta, Mo, W, Zr, Nb, Ti, TaSi, and oxides or nitrides of those materials, for example.

The filling material 28 may be made of SiO₂, Al₂O₃, TiO₂, oxide such as ferrite, nitride such as AlN, carbide such as SiC, and nonmagnetic metal such as Cu and Cr, for example.

A coating member 35 for partially coating a top surface 28A of the filling material 28 is provided on the filling material 28. The surface roughness of a top surface of the coating member 35 and a portion of the filling material 28 which is not coated with the coating member 35 is larger than that of a top surface of the stop film 34 on the recording elements 25. As a specific material for the coating member 35, Mo, Cr, and Zr can be used, for example.

A protective layer 36 and a lubricating layer 38 are formed in that order on the stop film 34 (located on the recording elements 25), the filling member 28, and the coating member 35. The aforementioned surface 32 is a top surface of the lubricating layer 38. The protective layer 36 and the lubricating layer 38 are formed to follow the shape of the top surface of the stop film 34, the top surface of the coating member 35 and the top surface of the portion of the filling material 28 that is not coated with the coating member 35. Due to this, the surface roughness of the portion of the surface 32 above the filling material 28 is made larger than the surface roughness of the portions of the surface 32 above the recording elements 25.

The protective layer 36 has a thickness of 1 to 5 nm. The protective layer 36 may be made of hard carbon that is called as diamond-like carbon can be used, for example. Please note that the term “diamond-like carbon (hereinafter, referred to as “DLC”) employed herein shall mean a material that mainly contains carbon and has an amorphous structure and Vickers hardness of about 2×10⁹ to about 8×10¹⁰ Pa. The lubricating layer 38 has a thickness of 1 to 2 nm. The lubricating layer 38 may be made of PFPE (perfluoropolyether), for example.

An underlayer 40, an antiferromagnetic layer 42, a soft magnetic layer 44, and a seed layer 46 for providing magnetic anisotropy in a thickness direction (i.e., a direction perpendicular to the surface) to the recording layer 24 are formed between the substrate 22 and the recording layer 24. The underlayer 40 has a thickness of 2 to 40 nm. The underlayer 40 may be made of Ta, for example. The antiferromagnetic layer 42 has a thickness of 5 to 50 nm and may be made of PtMn alloys, RuMn alloys, or the like. The soft magnetic layer 44 has a thickness of 50 to 300 nm. The soft magnetic layer 44 may be made of Fe (iron) alloys, Co (cobalt) amorphous alloys, ferrite, or the like. The soft magnetic layer 44 may be formed by a multilayer structure of a soft magnetic layer and a nonmagnetic layer. The seed layer 46 has a thickness of 2 to 40 nm. Specific examples of the material for the seed layer 46 include nonmagnetic CoCr alloys, Ti, Ru, laminates of Ru and Ta, and MgO.

Next, an operation of the magnetic recording and reproducing apparatus 10 will be described.

Since the surface roughness of the portion of the surface 32 of the magnetic recording medium 12 above the filling material 28 is large, crash of the magnetic head 14 caused by stiction cannot easily occur.

Moreover, a texture effect is given by making the surface roughness of the portion of the surface 32 above the filling material 28 larger. Therefore, rigidity of an air film between the magnetic recording medium 12 and the magnetic head 14 is higher than that obtained in a structure in which a texture effect is given by providing a step between the portion of the surface above the recording element and the portion of the surface above the filling material. Due to this, a variation in a flying height of the magnetic head 14 can be suppressed. In addition, the surface roughness of the portions of the surface 32 above the recording elements 25 is small. This also suppresses the variation in the flying height of the magnetic head 14, so that good magnetic characteristics can be obtained.

Moreover, since the surface roughness of the top surface 25A of the recording elements 25 is small, the variation in the magnetic gap between the recording elements 25 and the magnetic head 14 is suppressed. Due to this, good magnetic characteristics can also be obtained.

Furthermore, the recording elements 25 are arranged to form tracks in the data areas of the magnetic recording medium 12. Therefore, problems such as erroneous recording of information on a track adjacent to a target track and crosstalk during reproduction cannot easily occur, although the areal density is high.

In the magnetic recording medium 12, the recording elements 25 are separated from each other and no recording layer 24 exists in the concave portions 26 between the recording elements 25. Therefore, no noise is generated from the concave portions 26. Also in this respect, good recording/reproduction characteristics can be obtained.

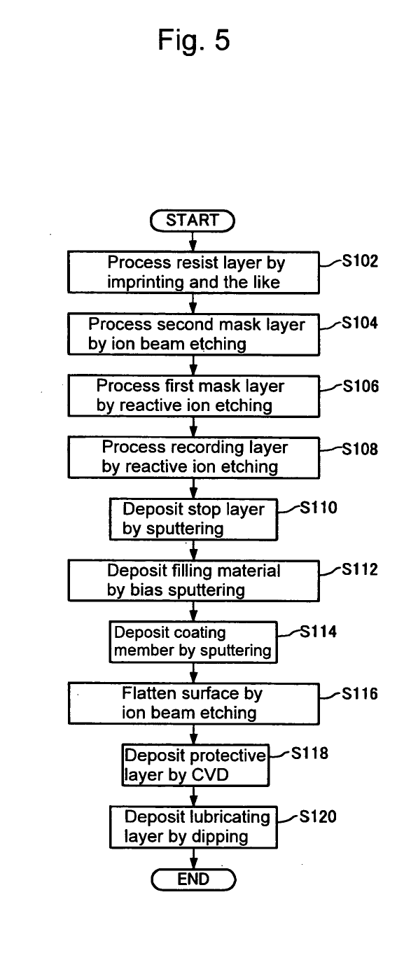

Next, a method for manufacturing the magnetic recording medium 12 will be described with reference to a flowchart shown in FIG. 5.

First, the underlayer 40, the antiferromagnetic layer 42, the soft magnetic layer 44, the seed layer 46, and a continuous recording layer (an unprocessed recording layer 24), a first mask layer, and a second mask layer are formed over the substrate 22 in that order by sputtering or the like. Then, a resist layer is formed by spin coating. In this manner, a starting structure of a workpiece is prepared. The first mask layer may be made of TaSi, for example. The second mask layer may be made of Ni, for example. The resist layer may be made of NEB22A (manufactured by Sumitomo Chemical Co., Ltd.), for example.

A concavo-convex pattern corresponding to a servo pattern in the servo areas and a track pattern in the data areas is transferred onto the resist layer by nano-imprinting using a transfer apparatus (not shown). The resist layer under the bottom of the concave portions is then removed by reactive ion beam etching using O₂ gas (S102). Then, the second mask layer under the bottom of the concave portions is removed by ion beam etching using Ar gas (S104), the first mask layer under the bottom of the concave portions is removed by reactive ion etching using SF₆ gas as reactive gas (S106), and thereafter the continuous recording layer under the bottom of the concave portions is removed by reactive ion etching using CO gas and NH₃ gas as reactive gas so as to divide the continuous recording layer into a number of recording elements 25 and form the recording layer 24 in the concavo-convex pattern (S108). Incidentally, the first mask layer remaining on the recording elements 25 are completely removed by the reactive ion etching using SF₆ gas as reactive gas.

Then, the stop film 34 is deposited on the recording elements 25 by sputtering (S110). The stop film 34 is also deposited on side faces of the recording elements 25 and the bottom of the concave portions 26.

As shown in FIG. 6, the filling material 28 is deposited on the stop film 34 of the workpiece 50 by bias sputtering, thereby filling the concave portions 26 between the recording elements 25 with the filling material 28 (S112). It is preferable to use a material having an amorphous or microcrystalline structure as the filling material 28 because formation of a gap cannot easily occur on the side faces and the bottom of the concave portions 26 and adhesion to the stop film 34 is improved. As used herein, the “material having a microcrystalline structure” shall mean a material that does not have a crystalline peak in X-ray diffraction. SiO₂ has a microcrystalline structure in which grain growth is suppressed, and can have an amorphous structure when a deposition condition is appropriately selected. Therefore, it is preferable to use SiO₂ as the filling material 28. The filling material 28 is deposited on the workpiece 50 covering the recording elements 25 to have a shape in which concavities and convexities of its surface are suppressed to some extent. When the filling material 28 in the concave portions 26 reaches a position near the top surface of the stop film 34 on the recording elements 25, deposition of the filling material 28 is stopped. Please note that FIG. 6 emphasizes the concavo-convex pattern on the top surface of the filling material 28 for understanding of the first exemplary embodiment.

The coating member 35 is then deposited on the filling material 28 by sputtering, as shown in FIG. 7 (S114).

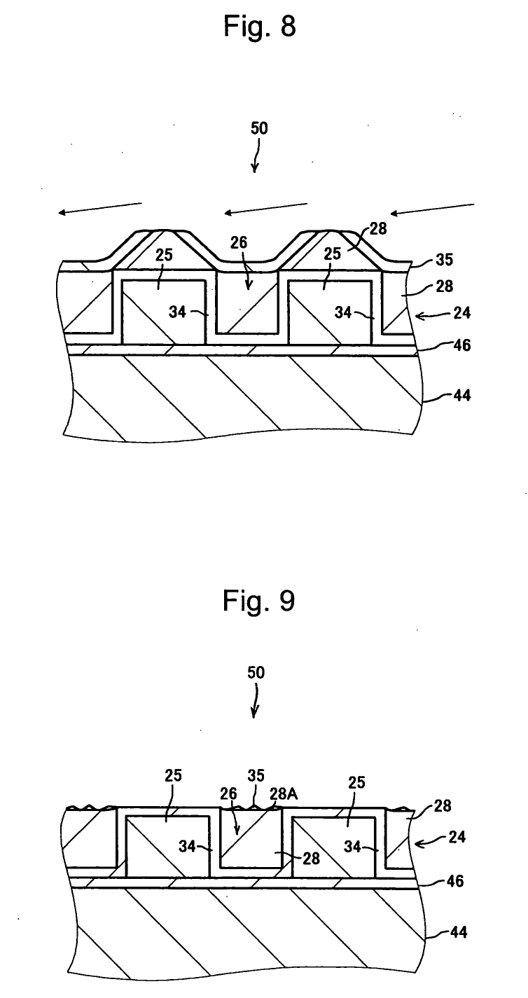

While the workpiece 50 is rotated, ion beam etching using Ar gas is performed so as to remove the coating member 35 and the filling material 28 from the surface of the workpiece 50 and flatten that surface, as shown in FIG. 8 (S116). In ion beam etching, an incident angle of process gas (Ar gas) with respect to the surface of the workpiece 50 is tilted from a direction perpendicular to the surface of the workpiece 50, as shown with an arrow in FIG. 8. Due to this, tendency that an etching rate for the convex portion is higher than that for the concave portion becomes remarkable. Especially when using noble gas such as Ar as the process gas, an anisotropic etching effect becomes higher. Thus, the tendency that the etching rate for the convex portion is higher than that for the concave portion becomes more remarkable. Since the coating member 35 above the recording element 25 forms a convex portion, it is removed faster than the coating member 35 above the concave portion 26 and the filling material 28 above the recording element 25 is exposed from the coating member 35. When that etching further makes progress, the filling material 28 above the recording element 25 is removed. Since the filling material 28 above the recording element 25 also forms a convex portion, it is removed faster than the filling material 28 in the concave portion 26 and the coating member 35 formed thereon. The filling material 28 in the concave portion 26 is coated with the coating member 35. Therefore, in order to selectively remove a portion of the filling material 28 above the recording element 25 faster, it is preferable to use an etching method in which an etching rate for the filling material 28 is higher than that for the coating member 35. In ion beam etching using Ar gas, an etching rate for SiO₂ is higher than that for Mo. Therefore, in case of using SiO₂ as the filling material 28 and Mo as the coating member 35, the above condition is satisfied.

Flattening is stopped when the coating member 35 and filling material 28 above the recording element 25 are completely removed to expose the stop film 34 and the coating member 35 on the filling material 28 in the concave portion 26 is partially removed to make a height of the top surface of the filling material 28 in the concave portion 26 and a height of the top surface of the remaining coating member 35 approximately the same as a height of the top surface of the stop film 34 on the recording element 25, as shown in FIG. 9. Allowing the coating member 35 to partially remain on the filling material 28 in the concave portion 26 as described above can make the surface roughness of the top surface of the coating member 35 and the portion of the filling material 28 that is not coated with the coating member 35 larger than the surface roughness of the top surface of the stop film 34 on the recording element 25. In this step, the filling material 28 partially exposed from the coating member 35 is temporarily etched by using the coating member 35 as a mask. Therefore, it is preferable to use an etching method in which an etching rate for the filling material 28 is higher than that for the coating member 35 because an effect of making the surface roughness of the top surface of the coating member 35 and the portion of the portion of the filling material 28 that is not coated with the coating member 35 larger can be enhanced. In ion beam etching using Ar gas, the etching rate for SiO₂ is higher than that for Mo, as described above. Therefore, in case of using SiO₂ as the filling material 28 and Mo as the coating member 35, the above condition is satisfied. Incidentally, even if the top surface of the filling material 28 on the stop film 34 has a certain level of concavities and convexities immediately before the stop film 34 is exposed, the use of an etching method in which an etching rate for the stop film 34 is lower than that for the filling material 28 can suppress concavities and convexities that are formed in the top surface of the stop film 34 based on the concavities and convexities in the top surface of the filling material 28, by a difference of the above etching rates. In ion beam etching using Ar gas, an etching rate for Ta is lower than that for SiO₂. Therefore, in case of using Ta as the stop film 34 and using SiO₂ as the filling material 28, the above condition is satisfied.

Next, the protective layer 36 of DLC is formed on the top surface of the stop film 34 (on the recording elements 25) and on the top surface of the filling material 28 by CVD to have a thickness of about 2 nm (S118) and thereafter the lubricating layer 38 of PFPE is formed on the protective layer 36 by dipping to have a thickness of 1 to 2 nm (S120). The protective layer 36 and the lubricating layer 38 are deposited following the shapes of the top surface of the stop film 34 (on the recording element 25), the coating member 35, and the filling material 28 that is not coated with the coating member 35. A top surface of the lubricating layer 38, i.e., the surface 32 has a surface roughness that is larger above the filling material 28 than above the recording elements 25, as shown in FIGS. 3 and 4.

As described above, the surface roughness of the portion of the surface 32 above the filling material 28 can be made larger than that of the portions of the surface 32 above the recording elements 25 by using the process for depositing the filling material 28 over the recording layer 24 to fill the concave portion 26 with the filling material 28 and the flattening process. Therefore, better productivity can be obtained as compared with a technique for performing a texture process for a substrate to form a texture pattern in a surface. Moreover, the top surface of the coating member 35 and the portion of the filling material 28 that is not coated with the coating member 35, that are closer to the surface 32 than the top surface of the substrate, are processed in a shape having a larger surface roughness and thereafter the protective layer 36 and the lubricating layer 38 are formed following that shape. Thus, the concavo-convex shape of the portion of the surface 32 above the filling material 28 can be made closer to a desired shape accordingly.

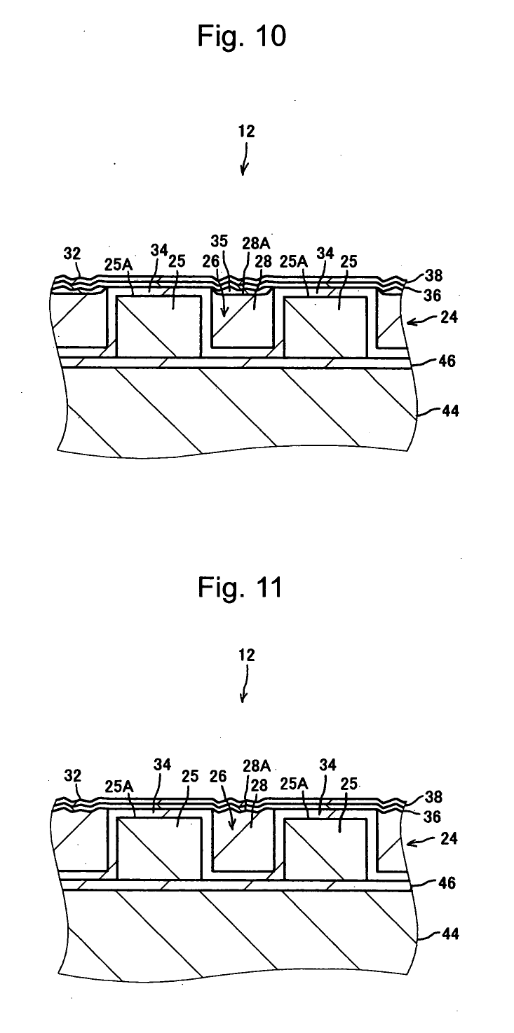

In the first exemplary embodiment, the coating member 35 partially coating the top surface 28A of the filling material 28 is provided on the filling material 28 in the magnetic recording medium 12, thereby making the surface roughness of the portion of the surface 32 above the filling material 28 larger than that of the portions of the surface 32 above the recording elements 25. Alternatively, the coating member 35 in which a surface roughness of its top surface is larger than that of the top surface of the stop film 34 may completely coat the top surface 28A of the filling material 28, thereby making the surface roughness of the portion of the surface 32 above filling material 28 larger than that of the portions of the surface 32 above the recording elements 25, as in a second exemplary embodiment of the present invention shown in FIG. 10. In the case where the coating member 35 completely coats the top surface 28A of the filling material 28, as described above, even if the surface roughness of the top surface 28A of the filling material 28 is small, the surface roughness of the portion of the surface 32 above the filling material 28 can be made larger than that of the portions of the surface 32 above the recording elements 25 by making the surface roughness of the top surface of the coating member 35 larger than that of the top surface 28A of the filling material 28.

Incidentally, in case of manufacturing a magnetic recording medium having that structure, in the flattening step (S116), etching can be stopped before the top surface 28A of the filling material 28 in the concave portion 26 is exposed. Also in this case, even if a certain level of concavities and convexities are formed in the top surface of the filling material 28 on the stop film 34 immediately before the stop film 34 is exposed, the use of the etching method in which the etching rate for the stop film 34 is lower than that for the filling material 28 can suppress concavities and convexities that are formed in the top surface of the stop film 34 based on the concavities and convexities of the top surface of the filling material 28, by a difference between the above etching rates. Therefore, the surface roughness of the top surface of the coating member 35 can be made larger than that of the top surface of the stop film 34 on the recording elements 25. In ion beam etching using Ar gas, an etching rate for Ta is lower than that for SiO₂, as described above. Therefore, when using Ta as the stop film 34 and using SiO₂ as the filling material 28, the above condition is satisfied. It is preferable to use a material in which its surface can be easily roughened along grain boundaries by etching, such as Cu and Cr, as a material for the coating member 35 in order to make the surface roughness of the top surface of the coating member 35 larger.

In the above first and second exemplary embodiments, the coating member 35 is made remain on the filling material 28 in the concave portions 26, thereby making the surface roughness of the portion of the surface 32 above the filling material 28 larger than that of the portions of the surface 32 above the recording elements 25. Alternatively, as in a third exemplary embodiment of the present invention shown in FIG. 11, the coating member 35 on the filling material 28 in the concave portion 26 may be completely removed so as to make the surface roughness of the top surface 28A of the filling material 28 in the concave portion 26 larger than that of the top surface of the stop film 34 on the recording elements 25, thus making the surface roughness of the portion of the surface 32 above the filling material 28 larger than that of the portions of above the recording elements 25.

In this case, in the flattening step (S116), the filling material 28 that is partially exposed from the coating member 35 is temporarily etched by using the coating member 35 as a mask. Thus, when the etching method in which the etching rate for the filling material 28 is higher than that for the coating member 35 is used, the surface roughness of the top surface 28A of the filling material 28 in the concave portion 26 can be made larger than that of the top surface of the stop film 34 on the recording element 25 even if the coating member 35 on the filling material 28 is completely removed. In ion beam etching using Ar gas, the etching rate for SiO₂ is higher than that for Mo, as described above. Therefore, when using SiO₂ as the filling material 28 and Mo as the coating member 35, the above condition is satisfied. Moreover, also in this case, even if the top surface of the filling material 28 on the stop film 34 has a certain level of concavities and convexities immediately before the stop film 34 is exposed, the use of the etching method in which the etching rate for the stop film 34 is lower than that for the filling material 28 in the flattening step (S116) can suppress concavities and convexities that are formed in the top surface of the stop film 34 based on the concavities and convexities of the top surface of the filling material 28 by a difference between the above etching rates.

In an alternative method, the coating member deposition step (S114) is omitted and a material that allows its surface to be easily roughened along grain boundaries by etching, e.g., Cu and Cr, is used as the filling material 28. In this case, the surface roughness of the top surface 28A of the filling material 28 in the concave portions 26 can be made larger than that of the top surface of the stop film 34 on the recording elements 25, thereby making the surface roughness of the portion of the surface 32 above the filling material 28 larger than that of the portions of above the recording elements 25.

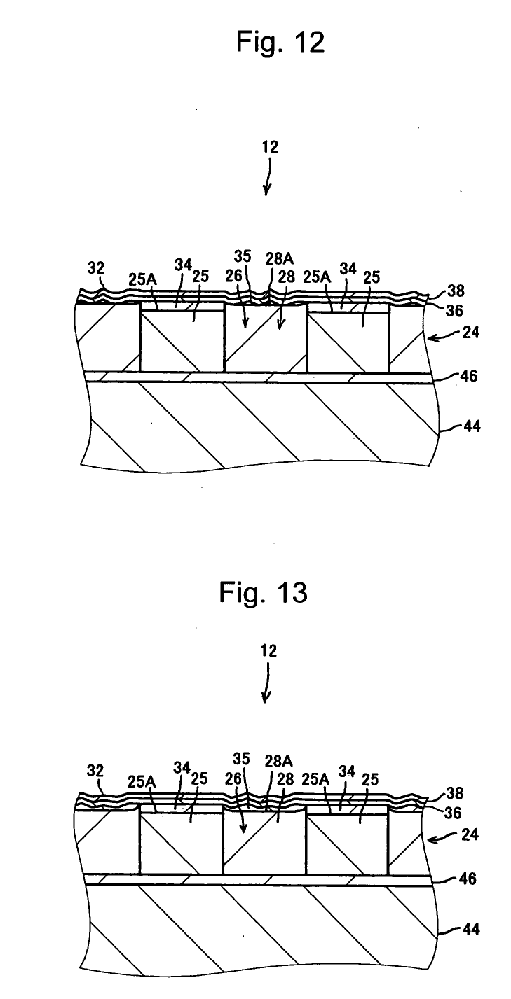

In the above first to third exemplary embodiments, the stop film 34 is formed not only on the top surface of the recording elements 25 but also on the side faces of the recording elements 25 and the bottom of the concave portions 26 in the magnetic recording medium 12. Alternatively, as in fourth, fifth, and sixth exemplary embodiments of the present invention that are respectively shown in FIGS. 12, 13, and 14, the stop film 34 may be formed only on the top surface of the recording elements 25.

In order to form the stop film 34 only on the top surface of the recording elements 25, it is only necessary to form the stop film between the continuous recording layer and the first mask layer in advance and then process the stop film 34 together with the continuous recording layer to divide them. Also in this case, it is also preferable to use a material having an amorphous or microcrystalline structure as the filling material 28 from a viewpoint that formation of a gap cannot easily occur on the side faces and the bottom of the concave portions 26 and adhesion to the side faces of the recording elements 25 is improved. When using the material having the amorphous or microcrystalline structure as the filling material 28, as described above, it is preferable that the coating member 35 partially or completely coat the top surface 28A of the filling material 28 as in the fourth and fifth exemplary embodiments in order to enhance the effect of making the surface roughness of the surface above the filling material 28 larger.

In the above first to sixth exemplary embodiments, the stop film 34 is formed on the recording elements 25 in the magnetic recording medium 12. Alternatively, if damage of the recording elements 25 caused by etching in the flattening step (S116) does not matter, the stop film 34 may be omitted, as in seventh, eighth, and ninth exemplary embodiments of the present invention that are shown in FIGS. 15, 16, and 17, respectively. Also in this case, it is also preferable to use a material having an amorphous or microcrystalline structure as the filling material 28 from a viewpoint that formation of a gap cannot easily occur on the side faces and the bottom of the concave portions 26 and adhesion to the side faces of the recording elements 25 is improved. Also in this case, in order to enhance the effect of making the surface roughness of the surface above the filling material 28 larger, it is also preferable that the coating member 35 partially or completely coat the top surface 28A of the filling material 28 as in the above seventh and eighth exemplary embodiments.

In this case, even if the top surface of the filling material 28 above the recording elements 25 has a certain level of concavities and convexities immediately before the recording element 25 is exposed in the flattening step (S116), the use of an etching method in which an etching rate for the recording elements 25 is lower than that for the filling material 28 can suppress concavities and convexities that are formed in the top surface of the recording element 25 based on the concavities and convexities of the top surface of the filling material 28, by a difference of the above etching rates. In ion beam etching using Ar gas, an etching rate for CoCr alloys and FePt alloys is lower than that for SiO₂. Therefore, when CoCr alloy or FePt alloy is used as the material for the recording layer 24 and SiO₂ is used as the filling material 28, the above condition is satisfied.

In the above first to ninth exemplary embodiments, a height of the portions of the surface 32 above the recording elements 25 is approximately the same as a height (of a highest site of) of the portion of the surface 32 above the filling material 28. Alternatively, a small step having a height of 2.5 nm or less, for example, may be provided between the portion of the surface 32 above the recording element 25 and the portion of the surface 32 above the filling material 28, as long as sufficient rigidity of an air film between the magnetic recording medium 12 and the magnetic head 14 is ensured. In this case, it is preferable that the portion of the surface 32 above the filling material 28 be higher than the portion of the surface 32 above the recording element 25 because an effect of preventing stiction of the magnetic head 14 can be enhanced and the recording element 25 can be protected against contact with the magnetic head 14. On the other hand, from a viewpoint that the magnetic gap between the magnetic head 14 and the recording element 25 is kept small, it is preferable that the portion above the recording element 25 be higher than the portion above the filling material 28. Also in this case, the effect of suppressing occurrence of crash of the magnetic head caused by stiction can be obtained to a certain degree by making the surface roughness of the surface 32 above the filling material 28 larger than that of the surface 32 above the recording elements 25.

In the above first to sixth exemplary embodiments, the protective layer 36 and the lubricating layer 38 are formed over the stop film 34 (on the recording elements 25) and the filling material 28. Alternatively, the top surface of the stop film 34 and the filling material 28 may be exposed. Similarly, although the protective layer 36 and the lubricating layer 38 are formed over the recording elements 25 and the filling material 28 in the seventh to ninth exemplary embodiments, the top surface of the recoding elements 25 and filling material 28 may be exposed.

In the above first to ninth exemplary embodiments, the underlayer 40, the antiferromagnetic layer 42, the soft magnetic layer 44, and the seed layer 46 are formed between the substrate 22 and the recording layer 24. However, the structure of the layers between the substrate 22 and the recording layer 24 can be changed in an appropriate manner in accordance with a type of magnetic recording medium or needs. Alternatively, the underlayer 40, the antiferromagnetic layer 42, the soft magnetic layer 44, and the seed layer 46 may be omitted so that the recording layer 24 is formed on the substrate 22 directly.

In the above first exemplary embodiment, the first mask layer, the second mask layer, and the resist layer are formed over the continuous recording layer and thereafter the continuous recording layer is divided by three steps of dry etching. However, materials for the resist layer and the mask layers, the number of those layers, the thickness of each of those layers, the type of dry etching, and the like are not specifically limited as long as the continuous recording layer can be divided with high precision.

In the above first to ninth exemplary embodiments, ion beam etching using Ar gas is described as an exemplary etching method performed in the flattening step (S116). However, the etching method performed in the flattening step (S116) is not specifically limited as long as the surface can be flattened to make the surface roughness of the portion of the surface above the filling material 28 (in the concave portion 26) larger than that of the portions of the surface above the recording elements 25. Preferable combinations of the etching method in the flattening step, the filling material, and the material for the coating member are shown in Table 1.

TABLE 1

| Type of dry etching | | Filling | |
|---|---|---|---|
| Process gas | Irradiation angle | material | Coating member |
| Noble gases | −10° or more | SiO₂ | Mo, Cr, Zr, |
| such as | and 90° or less | | Nb, W, C, Ta, |
| Ar, Xe | (All angles) | | TiN, TaSi |
| | | Si | C |
| | | Al | C |
| | | Au | Al |
| | | | C |
| | | Resist AZ | C |
| | 45° or more and 90° | Al | SiO₂ |
| | or less | | Si |
| | 40° or more and 90° | Al | Resist AZ |
| | or less | | |
| | 30° or more and 90° | SiO₂ | Resist AZ |
| | or less | Si | Resist AZ |
| | | Au | Resist AZ |
| | | | Si |
| | | | SiO₂ |
| | −10° or more | SiO₂ | Al |
| | and 45° or less | Si | Al |
| | −10° or more and | SiO₂ | Si |
| | 40° or less | Resist AZ | Al |
| | −10° or more and | SiO₂ | Au |
| | 30° or less | Resist AZ | Au |
| | | | Si |
| | | | SiO₂ |
| Halogen | −10° or more | SiO₂, Si, | Al, Ni, Au, |
| containing | and 90° or less | TaSi, | |
| gases | (All angles) | TiN, | |
| containing | | Ta, ITO, | |
| F, Cl, | | MgO, Al₂O₃ | |
| and the like | | | |
| O₂ gas | −10° or more | C, Resist AZ | Mo, Cr, Zr, |
| | and 90° or less | | Nb, W, TiN, |
| | (All angles) | | Ta, ITO, |
| | | | MgO, Al₂O₃, |
| | | | Al, Ni, Au |

Resist AZ: Clariant AZ resist material
ITO: Indium Tin Oxide

Although the magnetic recording medium 12 is a perpendicular recording type magnetic disk in the above first to ninth exemplary embodiments, the various exemplary embodiments of the present invention can also be applied to a longitudinal recording type magnetic disk.

In the above first to ninth exemplary embodiments, the recording layer 24 and other layers are formed on one side of the substrate 22 in the magnetic recording medium 12. However, the various exemplary embodiments of the present invention can also be applied to a double-side recording type magnetic recording medium in which a recording layer and other layers are formed on both sides of a substrate.

In the above first to ninth exemplary embodiments, the magnetic recording medium 12 is a discrete track medium. However, the various exemplary embodiments of the present invention can also be applied to a patterned medium and a magnetic disk including a spirally formed track, for example. Moreover, the various exemplary embodiments of the present invention can also be applied to magneto-optic discs such as an MO, heat assisted magnetic disks that use magnetism and heat together, and other magnetic recording media that have a shape different from the disk shape and include a recording layer formed in a concavo-convex pattern, such as a magnetic tape.

### WORKING EXAMPLE 1

Ten magnetic recording media 12 having the same structure as that described in the above first exemplary embodiment (see FIGS. 2 to 4) were manufactured. The main structure of the manufactured magnetic recording media 12 is now described.

The substrate 22 had a diameter of approximately 65 mm and was made of glass. The recording layer 24 had a thickness of approximately 20 nm and was made of a CoCrPt alloy. The filling material 28 was SiO₂. The stop film 34 had a thickness of approximately 3 nm and was made of Ta. The protective layer 36 had a thickness of approximately 2 nm and was made of DLC. The lubricating layer 38 had a thickness of approximately 1 nm and was made of PFPE. A track pitch (a pitch in a track-width direction between the recording elements 25) in the data area was approximately 200 nm and a width of the top surface of each recording element 25 (a track width) was approximately 100 nm.

In the stop film deposition step (S110), as a sputtering condition, a deposition power (a power applied to target) and a pressure inside a vacuum chamber were set to 500 W and 0.3 Pa, respectively.

In the filling material deposition step (S112), as a bias sputtering condition, a deposition power, a bias power applied to the workpiece 50, and a pressure inside the vacuum chamber were set to 500 W, 290 W, and 0.3 Pa, respectively. The deposition thickness of the filling material 28 was set to 19 nm that was thinner than the depth of the concave portion 26, 20 nm, by 1 nm. That is, the filling material 28 was deposited in such a manner that the top surface thereof in the concave portion 26 was lower than the top surface of the stop film 34 on the recording element 25 by 1 nm.

In the coating member deposition step (S114), as a sputtering condition, a deposition power and a pressure inside the vacuum chamber were set to 500 W and 0.3 Pa, respectively, and Mo was deposited as the coating member 35 to have a thickness of 3 nm.

In the flattening step (S116), as an ion beam etching condition, a beam voltage, a beam current, a pressure inside the vacuum chamber, and an irradiation angle of Ar gas with respect to the workpiece 50 were set to 700 V, 1100 mA, 0.04 Pa, and approximately 20, respectively. Etching was stopped when the coating member 35 on the filling material 28 in the concave portions 26 was partially removed and the top surface of the coating member 35 and the filling material 28 that was not coated with the coating member 35 was approximately coincident with the top surface of the stop film 34 on the recording elements 25. Then, the protective layer 36 was formed by CVD and the lubricating layer 38 was formed on the protective layer 36 by dipping.

For each of the thus obtained magnetic recording media 12, the arithmetical mean deviation (surface roughness) of the portions of the surface 32 above the filling material 28, the arithmetical mean deviation of the portions of the surface 32 above the recording elements 25, and the arithmetical mean deviation of the entire surface 32 were measured by means of AFM (Atomic Force Microscope). The measurement results are shown in Table 2. All values of the arithmetical mean deviation in Table 2 are average values of ten (10) magnetic recording media 12.

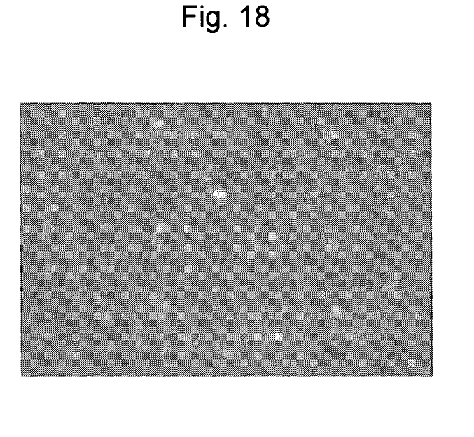

FIG. 18 shows an AFM image of one of those magnetic recording media 12, in which darkness and lightness of color represent a degree of concavity and convexity in the surface of that magnetic recording medium 12. More specifically, a lighter color represents that a corresponding portion projects more in the thickness direction, whereas a darker color represents that a corresponding portion becomes more concave. In FIG. 18, straight areas in which different levels of darkness are mixed and which have larger surface roughness and straight areas having a substantially constant darkness and having a smaller surface roughness are alternately arranged. The former areas correspond to the portions above the filling material 28 in the concave portions 26 and the latter areas correspond to the portions above the recording elements 25.

For each of ten magnetic recording media 12, a seek test of the magnetic head 14 was performed 100,000 times in a 2-mm width area away from a center in the radial direction by 18 to 20 mm. In the seek test, suspension load was adjusted to set a flying height of the magnetic head 14 to 10 nm. An average seek time was set to 12 ms. After the seek test, a mark of crash on the magnetic head 14 was checked. The measurement result of the crash mark is shown in Table 2 as the number of magnetic recording media 12 that caused the crash mark on the magnetic head 14.

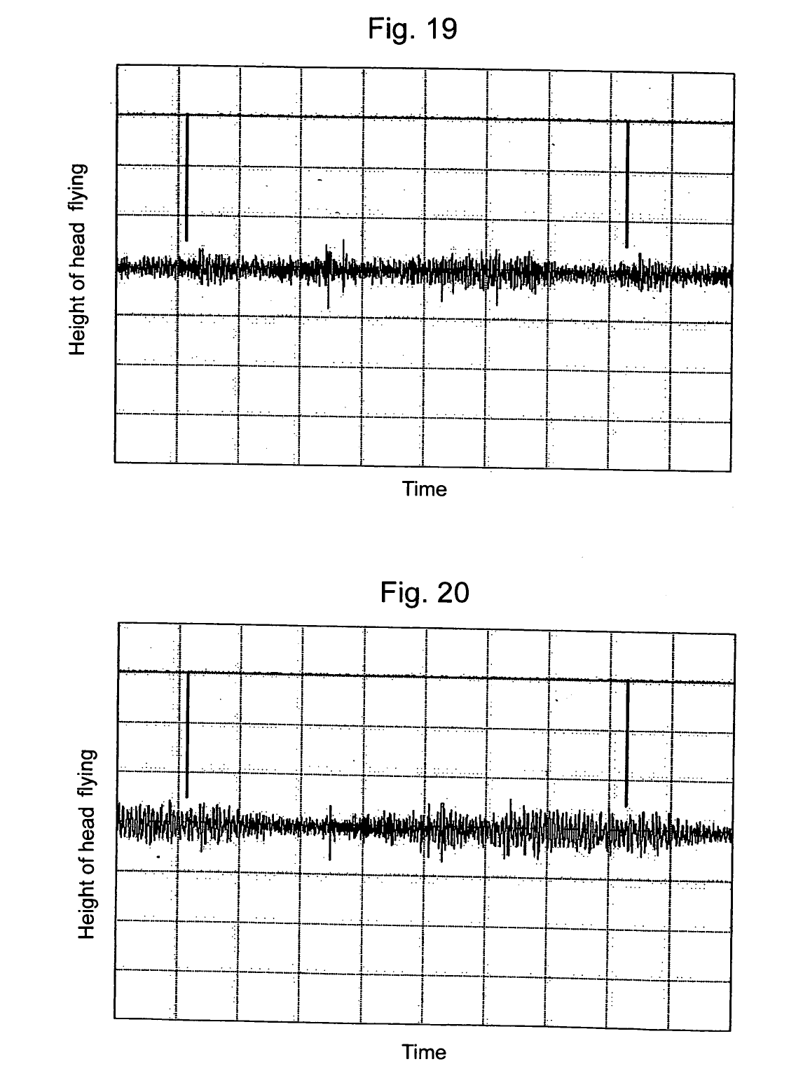

Moreover, the variation in the flying height of the magnetic head 14 was measured by means of LDV (Laser Doppler Vibrometer) while a flying position of a slider of the magnetic head 14 was kept at a position away from the center of the magnetic recording medium 12 in the radial direction by 20 mm. FIG. 19 is a graph showing the variation in the flying height of the magnetic head 14 for one of those magnetic recording media 12. Each vertical scale in FIG. 19 represents 2.5 nm. Two vertical lines above a curve that represents the variation in the flying height of the magnetic head 14 in FIG. 19 represent that data in an area defined by those two vertical lines is data of one revolution of the magnetic recording medium 12.

### WORKING EXAMPLE 2

Ten magnetic recording media 12 having the same structure as that described in the above third exemplary embodiment (see FIG. 11) were manufactured. More specifically, unlike Working Example 1, the filling material 28 was deposited to have a thickness of 21 nm, that was thicker than the depth of the concave portion 26, 20 nm, by 1 nm, in the filling material deposition step (S112). That is, the filling material 28 was deposited in such a manner that the top surface of the filling material 28 in the concave portions 26 was higher than the top surface of the stop film 34 on the recording elements 25 by 1 nm.

As the coating member 35, Mo was deposited to have a thickness of 3 nm in the coating member deposition step (S114), as in Working Example 1.

The coating member 35 was completely removed in the flattening step (S116). Except for the above, Working Example 2 was the same as Working Example 1.

For each of those magnetic recording media 12, the arithmetical mean deviation of the surface 32 above the filling material 28, the arithmetical mean deviation of the surface 32 above the recording elements 25, and the arithmetical mean deviation of the entire surface 32 were measured by means of AFM in the same manner as that in Working Example 1. The measurement results are shown in Table 2.

In addition, the seek test of the magnetic head 14 was performed for those magnetic recording media 12 in the same manner as that in Working Example 1, and thereafter the crash mark on the magnetic head 14 was checked. The measurement result of the crash mark is shown in Table 2 as the number of magnetic recording media 12 that caused the crash mark on the magnetic head 14.

### WORKING EXAMPLE 3

Unlike Working Example 1, a step having a height of approximately 2.5 nm was provided between the portion of the surface 32 above the filling material 28 and the portion above the recording element 25. More specifically, the filling material 28 was deposited to have a thickness of 17 nm that was thinner than the depth of the concave portion 26, 20 nm, by 3 nm in the filling material deposition step (S112). That is, the filling material 28 was deposited in such a manner that the top surface of the filling material 28 in the concave portions 26 was lower than the top surface of the stop film 34 on the recording elements 25 by 3 nm.

Moreover, in the flattening step (S116), etching was stopped when the coating member 35 was partially removed and the step between the top surface of the coating member 35 and the filling material 28 that was not coated with the coating member 35 and the top surface of the stop film 34 on the recording element 25 reached approximately 2.5 nm. Except for the above, conditions in Working Example 3 were set to the same as those in Working Example 1 and ten magnetic recording media 12 having the same structure as that described in the aforementioned first exemplary embodiment were manufactured.

For each of those magnetic recording media 12, the arithmetical mean deviation of the portion of the surface 32 above the filling material 28, the arithmetical mean deviation of the portion of the surface 32 above the recording element 25, and the arithmetical mean deviation of the entire surface 32 were measured by means of AFM in the same manner as that in Working Example 1. The measurement results are shown in Table 2.

In addition, the seek test of the magnetic head 14 was performed for those magnetic recording media 12 in the same manner as that in Working Example 1, and thereafter the crash mark on the magnetic head 14 was checked. The measurement result of the crash mark is shown in Table 2 as the number of magnetic recording media 12 that caused the crash mark on the magnetic head 14.

For each of those magnetic recording media 12, the variation in the flying height of the magnetic head 14 was measured in the same manner as that in Working Example 1. FIG. 20 is a graph showing the variation in the flying height of the magnetic head 14 for one of those magnetic recording media 12.

### COMPARATIVE EXAMPLE

Unlike Working Example 1, ten mirror-polished substrates were prepared and the protective layer 36 and the lubricating layer 38 were formed over those substrates. The materials and thicknesses of the protective layer 36 and the lubricating layer 38 were the same as those in Working Example 1. For those substrates, arithmetical mean deviation of the entire surface was measured by means of AFM. The measurement result is shown in Table 2. In addition, the seek test of the magnetic head 14 was performed for those substrates in the same manner as that in Working Example 1, and thereafter the crash mark on the magnetic head 14 was checked. The measurement results of the crash mark are shown as the number of substrates that caused the crash mark on the magnetic head 14.

For each of those substrates, the variation in the flying height of the magnetic head 14 was measured in the same manner as that in Working Example 1. FIG. 21 is a graph showing a variation in the flying height of the magnetic head 14 for one of those substrates.

TABLE 2

| | Arithmetical | Arithmetical | | | | |
|---|---|---|---|---|---|---|
| | mean deviation | mean deviation | | | | |
| | of portions of a | of portions of a | Arithmetical | Deposition | Deposition | Number of |
| | surface above | surface above a | mean deviation | thickness of a | thickness of a | media/ |
| | recording | filling material | of an entire | filling material | coating | substrates |
| | elements (nm) | (nm) | surface (nm) | (nm) | member (nm) | causing crash |
| Working | 0.31 | 0.73 | 0.54 | 19.0 | 3.0 | 0 |
| Example 1 | | | | | | |
| Working | 0.29 | 0.53 | 0.42 | 21.0 | 3.0 | 0 |
| Example 2 | | | | | | |
| Working | 0.33 | 0.78 | 0.89 | 17.0 | 3.0 | 0 |
| Example 3 | | | | | | |
| Comparative | — | — | 0.15 | — | — | 6 |
| Example | | | | | | |

As shown in Table 2, six of the ten substrates caused crash in Comparative Example, whereas no crash was caused for all the ten magnetic recording media 12 in each of Working Examples 1, 2, and 3. That is, it was confirmed that Working Examples 1, 2, and 3 had the significantly high effect of suppressing occurrence of crash, unlike Comparative Example. It is considered that in Comparative Example crash caused by stiction of the magnetic head could easily occur because the protective layer 36 and the lubricating layer 38 were formed over the mirror-polished substrate, whereas in Working Examples 1, 2, and 3 the surface roughness of the portion of the surface 32 above the filling material 28 was large and therefore crash caused by stiction of the magnetic head 14 could be suppressed.

On the other hand, the variation in the flying height of the magnetic head 14 in each of Working Examples 1 and 3 was approximately the same as that in Comparative Example in which the protective layer 36 and the lubricating layer 38 were formed over the mirror-polished substrate, as shown in FIGS. 19 to 21. This is because in Working Examples 1 and 3 the small surface roughness of the portions of the surface 32 above the recording elements 25 in the magnetic recording medium 12 suppressed the variation in the flying height of the magnetic head 14 to be approximately the same as that in Comparative Example. Moreover, the variation in the flying height of the magnetic head 14 in Working Example 3 was approximately the same as that in Comparative Example in which the protective layer 36 and the lubricating layer 38 were formed over the mirror-polished substrate, although in Working Example 3 the step having a height of approximately 2.5 nm was provided between the portion of the surface 32 above the filling material 28 and the portion above the recording element 25. This fact shows that, even if there is a step between the portion of the surface 32 above the filling material 28 and the portion above the recording element 25, good flying performance of the magnetic head 14 can be obtained when the height of the step is 2.5 nm or less. In FIGS. 19 to 21, the flying height of the magnetic head 14 suddenly and significantly increased at several portions. However, that sudden increase was caused by foreign particles such as dust, not by the shape of the surface 32 of the magnetic recording medium 12.

Working Examples 1, 2, and 3 and Comparative Example that are described above show that the effect of suppressing crash caused by stiction of the magnetic head can be obtained in the case where the arithmetical mean deviation of the portion of the surface of the magnetic recording medium above the filling material is larger than that of the portions of the surface above the recording elements. Moreover, in the case where another surface roughness value e.g., a mean height Rc, a maximum peak height Rp, a RMS (root-mean-square) roughness Rq, a maximum valley depth Rv, a maximum peak-to-valley roughness height Ry, or a ten-point mean roughness Rz, is larger above the filling material than above the recording elements, the effect of suppressing crash caused by stiction of the magnetic head can also be obtained.

The present invention can be applied to a magnetic recording medium including a recording layer formed in a predetermined concavo-convex pattern such as a discrete track medium and a patterned medium.

What is claimed is:

1. A magnetic recording medium comprising:
recording elements formed as convex portions of a recording layer formed in a predetermined concavo-convex pattern over a substrate; and
a filling material with which a concave portion between the recording elements is filled, and wherein a surface roughness of a portion of a surface of the medium above the filling material is larger than a surface roughness of portions of the surface above the recording elements.

2. The magnetic recording medium according to claim 1, wherein
an arithmetical mean deviation of the portion of the surface above the filling material is larger than an arithmetical mean deviation of the portions of the surface above the recording elements.

3. The magnetic recording medium according to claim 1, wherein
a surface roughness of a top surface of the recording elements is smaller than the surface roughness of the surface above the filling material.

4. The magnetic recording medium according to claim 1, further comprising
a coating member, provided over the filling material, for partially coating a top surface of the filling material.

5. The magnetic recording medium according to claim 3, further comprising
a coating member, provided over the filling material, for partially coating a top surface of the filling material.

6. The magnetic recording medium according to claim 1, further comprising:
a coating member, provided over the filling material, for coating a top surface of the filling material; and a protective layer formed over the coating member and the recording elements.

7. The magnetic recording medium according to claim 3, further comprising:
a coating member, provided over the filling material, for coating a top surface of the filling material; and a protective layer formed over the coating member and the recording elements.

8. The magnetic recording medium according to claim 4, wherein
the filling material has either one of an amorphous structure and a microcrystalline structure.

9. The magnetic recording medium according to claim 6, wherein
the filling material has either one of an amorphous structure and a microcrystalline structure.

10. A magnetic recording and reproducing apparatus comprising:
the magnetic recording medium according to claim 1; and
a magnetic head arranged to fly close to the surface of the magnetic recording medium for recording and reproducing data for the magnetic recording medium.

11. A method for manufacturing a magnetic recording medium comprising:
a filling material deposition step for depositing a filling material over a recording layer that is formed in a predetermined concavo-convex pattern over a substrate and includes recording elements formed as convex portions of the concavo-convex pattern, to fill a concave portion between the recording elements with the filling material;
a coating member deposition step for depositing a coating member made of a different material from the filling material over the filling material; and
a flattening step for removing an excess part of the filling material and coating member that is higher than a top surface of the recording elements by etching, and flattening a surface to make a surface roughness of a portion of the surface above the concave portion larger than a surface roughness of portions of the surface above the recording elements.

12. The method for manufacturing a magnetic recording medium according to claim 11, wherein
the flattening step uses an etching method in which an etching rate for the filling material is higher than an etching rate for the coating member.

13. The method for manufacturing a magnetic recording medium according to claim 11, wherein
the flattening step uses an etching method in which an etching rate for the recording layer is lower than an etching rate for the filling material.

14. The method for manufacturing a magnetic recording medium according to claim 12, wherein
the flattening step uses an etching method in which an etching rate for the recording layer is lower than an etching rate for the filling material.

15. The method for manufacturing a magnetic recording medium according to claim 11, wherein further comprising
a stop film deposition step for depositing a stop film over the recording layer before the filling material deposition step, and wherein the flattening step uses an etching method in which an etching rate for the stop film is lower than an etching rate for the filling material.

16. The method for manufacturing a magnetic recording medium according to claim 12, wherein further comprising
a stop film deposition step for depositing a stop film over the recording layer before the filling material deposition step, and wherein the flattening step uses an etching method in which an etching rate for the stop film is lower than an etching rate for the filling material.

17. The method for manufacturing a magnetic recording medium according to claim 11, wherein
the excess part of the filling material and coating member is removed to make the coating member partially remain on the filling material in the concave portion in the flattening step.

18. The method for manufacturing a magnetic recording medium according to claim 12, wherein
the excess part of the filling material and coating member is removed to make the coating member partially remain on the filling material in the concave portion in the flattening step.

19. The method for manufacturing a magnetic recording medium according to claim 13, wherein
the excess part of the filling material and coating member is removed to make the coating member partially remain on the filling material in the concave portion in the flattening step.

20. The method for manufacturing a magnetic recording medium according to claim 15, wherein
the excess part of the filling material and coating member is removed to make the coating member partially remain on the filling material in the concave portion in the flattening step.
